(19) United States
(12) Patent Application Publication
(10) Pub. No.: US 2025/0286377 A1
(43) Pub. Date: Sep. 11, 2025

(54) POWER DISTRIBUTION UNIT

(71) Applicant: Milwaukee Electric Tool Corporation, Brookfield, WI (US)

(72) Inventors: Steve J. Ennesser, Mequon, WI (US); Nathaniel A. Park, Brookfield, WI (US); Mathias Nunes, Mequon, WI (US); Connor P. Sprague, Milwaukee, WI (US); Ryan A. Kinney, Menomonee Falls, WI (US); Bradley M. Berkman, Highland Park, IL (US)

(21) Appl. No.: 19/072,422

(22) Filed: Mar. 6, 2025

Related U.S. Application Data
(60) Provisional application No. 63/562,759, filed on Mar. 8, 2024.
(60) Provisional application No. 63/674,099, filed on Jul. 22, 2024.

(51) Int. Cl. H02J 3/14

(52) U.S. Cl. CPC H02J 3/144; H02J 2310/60

(57) ABSTRACT

A power distribution unit includes a plurality of outlets and a controller. The controller is configured to poll the plurality of outlets to determine a polled electrical load of each outlet, add one or more outlets of the plurality of outlets to a queue based on a comparison of the polled electrical loads and a user set threshold, connect the queued outlets to a power input, monitor a total electrical load of the power distribution unit, and disconnect one or more outlets of the plurality of outlets from the power input in response to determining that the total electrical load exceeds the user set threshold.

### FIELD

The present disclosure relates to power distribution devices.

### SUMMARY

Embodiments described herein relate to power distribution devices and, more particularly, to power distribution devices for intelligently managing the charging of high-demand devices.

Charging multiple high-demand devices (such as power tool battery packs) simultaneously on a single circuit can result in a current or power draw that exceeds the circuit's rated capacity. This may cause the circuit breaker to trip, which may result in an interruption in the charging cycle until the circuit breaker can be reset. When the charging cycle is interrupted by a tripped circuit breaker, the charging devices may not receive a full charge, which may lead to reduced device availability and/or operational inefficiency. The interruptions associated with tripped circuit breakers can halt work, or, in the scenario where devices are charged overnight, result in devices being unavailable for use the next morning. Furthermore, frequent trips can also lead to premature wear on the circuit breaker.

Systems, apparatuses, methods, and techniques described herein effectively solve these and other technical problems by intelligently managing the current draw of multiple devices that may be plugged into a power distribution unit, sequencing the current drawn by each device based on the available current/power capacity, and ensuring that the circuit is not overloaded. When used to charge multiple-high demand devices, power distribution units implemented according to the present disclosure can automate the charging process and ensure that the devices plugged in to the power distribution units are effectively charged over time, eliminating the need for manual intervention and ensuring that the devices are fully charged and ready for use.

Power distribution units described herein include a plurality of outlets and a controller. The controller is configured to poll the plurality of outlets to determine a polled electrical load of each outlet, add one or more outlets of the plurality of outlets to a queue based on a comparison of the polled electrical loads and a user set threshold, connect the queued outlets to a power input, monitor a total electrical load of the power distribution unit, and disconnect one or more outlets of the plurality of outlets from the power input in response to determining that the total electrical load exceeds the user set threshold.

In some aspects, to poll the plurality of outlets, the controller is configured to connect a first pair of outlets of the plurality of outlets to the power input, measure an electrical load of each outlet of the first pair of outlets, and disconnect the first pair of outlets of the plurality of outlets from the power input.

In some aspects, each outlet of the plurality of outlets is assigned a priority. The controller, to poll the plurality of outlets, is configured to connect a second pair of outlets of the plurality of outlets to the power input, the second pair of outlets having a lower priority than the first pair of outlets, measure an electrical load of each outlet of the second pair of outlets, and disconnect the second pair of outlets of the plurality of outlets from the power input.

In some aspects, the controller, to add one or more outlets of the plurality of outlets to the queue, is configured to select a first outlet of the plurality of outlets, determine whether connecting the first outlet to the power input will cause the total electrical load of the power distribution unit to exceed the user set threshold, and add the first outlet to the queue in response to determining that connecting the first outlet to the power input will not cause the total electrical load of the power distribution unit to exceed the user set threshold.

In some aspects, each outlet of the plurality of outlets is assigned a priority. The controller, to add one or more outlets of the plurality of outlets to the queue, is configured to select a second outlet of the plurality of outlets, the second outlet having a lower priority than the first outlet, determine whether connecting the second outlet and any queued outlets to the power input will cause the total electrical load of the power distribution unit to exceed the user set threshold, and add the second outlet to the queue in response to determining that connecting the second outlet and any queued outlets to the power input will not cause the total electrical load of the power distribution unit to exceed the user set threshold.

In some aspects, the controller is configured to disconnect outlets from the power input in reverse priority order in response to determining that the total electrical load exceeds the user set threshold.

In some aspects, the controller is further configured to determine whether any additional outlets of the plurality of outlets can be connected to the power input without causing the total electrical load to exceed the user set threshold in response to determining that the total electrical load does not exceed the user set threshold, initiate a timer in response to determining that additional outlets of the plurality of outlets can be connected to the power input without causing the total electrical load to exceed the user set threshold, and connect the additional outlets to the power input in response to the timer elapsing.

In some aspects, the power distribution unit includes a plurality of switches, each switch of the plurality of switches being associated with a respective outlet of the plurality of outlets, a plurality of outlet sensors, each outlet sensor of the plurality of sensors being associated with a respective outlet of the plurality of outlets and configured to sense an electrical load of the respective outlet, and a main sensor configured to sense the total electrical load of the power distribution unit at the power input. The controller is configured to actuate each switch of the plurality of switches to connect or disconnect the respective outlet, determine an electrical load of each outlet by monitoring a respective outlet sensor, and determine the total electrical load of the power distribution unit by monitoring the main sensor.

In some aspects, the polled electrical loads and the total electrical load are current values.

In some aspects, the polled electrical loads and the total electrical load are power values.

Methods described herein for controlling a power distribution unit include polling a plurality of outlets of the power distribution unit to determine a polled electrical load of each outlet, adding one or more outlets of the plurality of outlets to a queue based on a comparison of the polled electrical loads and a user set threshold, connecting the queued outlets to a power input, monitoring a total electrical load of the power distribution unit, and disconnecting one or more outlets of the plurality of outlets from the power input in response to determining that the total electrical load exceeds the user set threshold.

In some aspects, polling the plurality of outlets includes connecting a first pair of outlets of the plurality of outlets to the power input, measuring an electrical load of each outlet of the first pair of outlets, and disconnecting the first pair of outlets of the plurality of outlets from the power input.

In some aspects, each outlet of the plurality of outlets is assigned a priority. Polling the plurality of outlets includes connecting a second pair of outlets of the plurality of outlets to the power input, the second pair of outlets having a lower priority than the first pair of outlets, measuring an electrical load of each outlet of the second pair of outlets, and disconnecting the second pair of outlets of the plurality of outlets from the power input.

In some aspects, adding one or more outlets of the plurality of outlets to the queue includes selecting a first outlet of the plurality of outlets, determining whether connecting the first outlet to the power input will cause the total electrical load of the power distribution unit to exceed the user set threshold, and adding the first outlet to the queue in response to determining that connecting the first outlet to the power input will not cause the total electrical load of the power distribution unit to exceed the user set threshold.

In some aspects, each outlet of the plurality of outlets is assigned a priority. Adding one or more outlets of the plurality of outlets to the queue comprises selecting a second outlet of the plurality of outlets, the second outlet having a lower priority than the first outlet, determining whether connecting the second outlet and any queued outlets to the power input will cause the total electrical load of the power distribution unit to exceed the user set threshold, and adding the second outlet to the queue in response to determining that connecting the second outlet and any queued outlets to the power input will not cause the total electrical load of the power distribution unit to exceed the user set threshold.

In some aspects, the method includes disconnecting outlets from the power input in reverse priority order in response to determining that the total electrical load exceeds the user set threshold. In some aspects, the method includes determining whether any additional outlets of the plurality of outlets can be connected to the power input without causing the total electrical load to exceed the user set threshold in response to determining that the total electrical load does not exceed the user set threshold, initiating a timer in response to determining that additional outlets of the plurality of outlets can be connected to the power input without causing the total electrical load to exceed the user set threshold, and connecting the additional outlets to the power input in response to the timer clapsing.

In some aspects, the power distribution unit includes a plurality of switches, each switch of the plurality of switches being associated with a respective outlet of the plurality of outlets, a plurality of outlet sensors, each outlet sensor of the plurality of sensors being associated with a respective outlet of the plurality of outlets and configured to sense an electrical load of the respective outlet, and a main sensor configured to sense the total electrical load of the power distribution unit at the power input. The method further includes actuating each switch of the plurality of switches to connect or disconnect the respective outlet, determining an electrical load of each outlet by monitoring a respective outlet sensor, and determining the total electrical load of the power distribution unit by monitoring the main sensor.

In some aspects, the polled electrical loads and the total electrical load are current values.

In some aspects, the polled electrical loads and the total electrical load are power values.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other examples, embodiments, features, and aspects will become apparent by consideration of the detailed description and accompanying drawings.

### BRIEF DESCRIPTION OF THE DRAWINGS

FIG. 1 illustrates a power distribution unit (“PDU”), according to some embodiments.

FIG. 2 illustrates a control system for the PDU of FIG. 1, according to some embodiments.

FIG. 3 illustrates an example process for controlling operation of the PDU of FIG. 1, according to some embodiments.

FIG. 4 illustrates an example process for polling outlets of the PDU of FIG. 1, according to some embodiments.

FIG. 5 illustrates an example process for turning on outlets of the PDU of FIG. 1, according to some embodiments.

FIG. 6 illustrates an example process for turning on outlets of the PDU of FIG. 1, according to some embodiments.

FIG. 7 illustrates an example process for turning on outlets of the PDU of FIG. 1, according to some embodiments.

FIG. 8 illustrates an example process for turning on outlets of the PDU of FIG. 1, according to some embodiments.

FIG. 9 illustrates an example process for controlling operation of the PDU of FIG. 1, according to some embodiments.

FIG. 10 illustrates an example process for turning on outlets of the PDU of FIG. 1, according to some embodiments.

FIGS. 11-13 illustrate an example process for controlling operation of the PDU of FIG. 1, according to some embodiments.

FIG. 14 illustrates an example process for controlling operation of the PDU of FIG. 1, according to some embodiments.

In the drawings, reference numbers may be reused to identify similar and/or identical elements.

### DETAILED DESCRIPTION

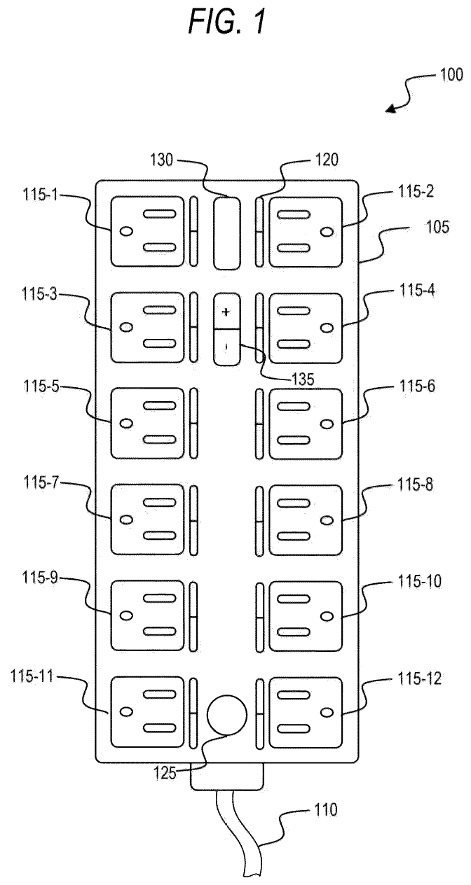

FIG. 1 illustrates a power distribution unit (“PDU”) 100. The PDU 100 includes a body or a housing 105 and an alternating current (“AC”) power input cord 110. The PDU 100 includes a plurality of outlets 115. In the illustrated example, the PDU 100 includes twelve outlets 115-1-115-12, but in other examples, the PDU may include any number of outlets 115. Each outlet 115 may have a priority. For example, the outlet 115-1 may have a highest priority, the outlet 115-2 may have a next highest priority, etc. Each outlet 115 may include one or more indicators 120 associated with the outlet 115. The indicators 120 can provide an indication of, for example, whether the outlet 115 is energized (e.g., is receiving power), a fault condition associated with the outlet 115 is present, etc. The PDU 100 also includes an ON/OFF button 125 for turning the PDU 100 ON and OFF, a display 130, and a user input 135. The display 130 may be configured to display, for example, a user set power threshold for the PDU 100 (e.g., 1000 W) or a user set amperage threshold (e.g., 15A). The user input 135 can be used to increase or decrease the user set power threshold or the user set amperage threshold.

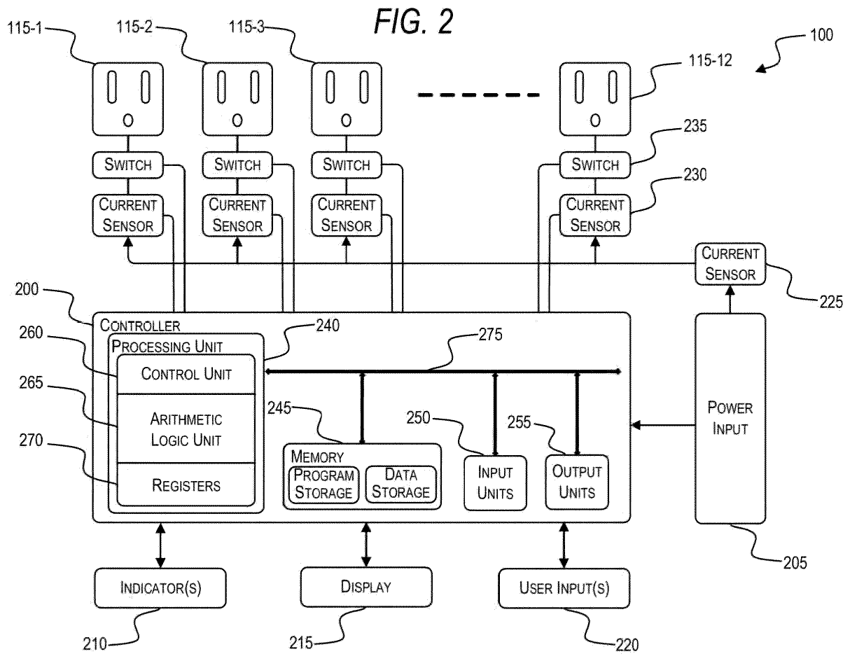

FIG. 2 illustrates a control system for the PDU 100. The control system includes a controller 200. The controller 200 is electrically and/or communicatively connected to a variety of modules or components of the PDU 100. For example, the illustrated controller 200 is electrically connected to a power input module 205 (e.g., an AC power input module), one or more indicators 210, a display 215 (e.g., display 130), one or more user inputs 220 (e.g., user inputs 135), a first current sensor 225, and a plurality of secondary current sensors 230. Connected between each outlet 115 and each current sensor 230 are a plurality of switches 235 (e.g., relays, semiconductor switches, etc.) for controlling whether power is provided to the outlets 115. In some embodiments, the PDU 100 also includes one or more vents, one or more fans, and one or more temperature sensors for controlling the temperature of the PDU 100. For example, a temperature sensor can be used to measure an internal temperature of the PDU 100. If the temperature is too high or reaches one or more threshold temperature values, the controller 200 can control one or more fans to try to reduce the temperature of the PDU 100.

The controller 200 includes combinations of hardware and software that are operable to, among other things, control the operation of the PDU 100, monitor the operation of the PDU 100, activate the one or more indicators 210 (e.g., an LED), etc. The current sensor 225 is configured to, for example, sense a total current being drawn by the PDU 100.

The controller 200 includes a plurality of electrical and electronic components that provide power, operational control, and protection to the components and modules within the controller 200 and/or the PDU 100. For example, the controller 200 includes, among other things, a processing unit 240 (e.g., a microprocessor, a microcontroller, an electronic controller, and electronic processor, or another suitable programmable device), a memory 245, input units 250, and output units 255. The processing unit 240 includes, among other things, a control unit 260, an arithmetic logic unit (“ALU”) 265, and a plurality of registers 270 (shown as a group of registers in FIG. 2) and is implemented using a known computer architecture (e.g., a modified Harvard architecture, a von Neumann architecture, etc.). The processing unit 240, the memory 245, the input units 250, and the output units 255, as well as the various modules or circuits connected to the controller 200 are connected by one or more control and/or data buses (e.g., common bus 275). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 245 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 240 is connected to the memory 245 and executes software instructions that are capable of being stored in a RAM of the memory 245 (e.g., during execution), a ROM of the memory 245 (e.g., on a generally permanent basis), or another non-transitory computer readable medium such as another memory or a disc. Software included in the implementation of the PDU 100 can be stored in the memory 245 of the controller 200. The software includes, for example, firmware, one or more applications, program data, filters, rules, one or more program modules, and other executable instructions. The controller 200 is configured to retrieve from the memory 245 and execute, among other things, instructions related to the control processes and methods described herein. In other constructions, the controller 200 includes additional, fewer, or different components.

The power input module 205 includes combinations of active and passive components to regulate or control the power received from the battery pack prior to power being provided to the controller 200.

The indicators 210 include, for example, one or more light-emitting diodes (“LEDs”). The indicators 210 can be configured to display conditions of, or information associated with, the PDU 100. For example, the indicators 210 are configured to indicate measured electrical characteristics of the PDU 100, the status of the PDU 100, etc. The one or more user input modules 220 may be operably coupled to the controller 200 to, for example, turn the PDU 100 on or off. In some embodiments, the one or more user input modules 220 may include a combination of digital and analog input or output devices required to achieve a desired level of operation for the PDU, such as one or more knobs, one or more dials, one or more switches, one or more buttons, etc. In some embodiments, the one or more user input modules 220 may receive signals wirelessly from a device external to the PDU 100 (e.g., a user's mobile phone).

The controller 200 is configured to selectively control the switches 235 to enable power output from one or more of the outlets 115. The controller 200 is connected to the current sensors 225, 230 for sensing and monitoring an overall current or power draw (e.g., electrical load) of the PDU 100 (e.g., using current sensor 225), as well as individual current or power draws (e.g., electrical loads) from the individual outlets 115 (e.g., using respective current sensors 230). If the overall current or power draw of the PDU 100 exceeds the user set current or power threshold for the PDU 100, the controller is configured to disable or de-energize one or more of the outlets 115. The controller 200 is also connected to the switches 235 for controlling an ON/OFF state of each of the switches 235. Various processes for controlling the energization of the outlets 115 are described below.

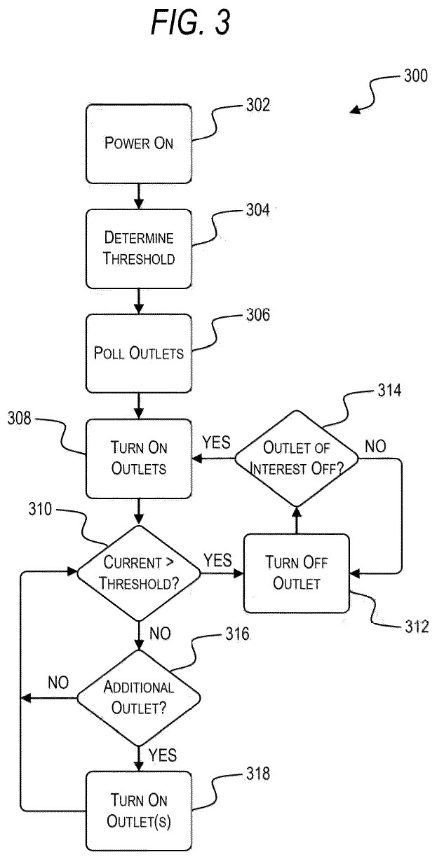

FIG. 3 illustrates an example process 300 for controlling operation of the PDU 100. In the example process 300, the PDU 100 may be powered on (at block 302). For example, a user may power on the PDU 100 by selecting the ON/OFF button 125 and define a user set current threshold or a user set power threshold (e.g., via the user input 135). In the example process 300, the controller 200 determines user set current threshold or the user set power threshold (at block 304). In various implementations, the user set current threshold or the user set power threshold must be set every time the PDU 100 is turned ON. In some examples, the controller 200 initializes the user set current threshold or the user set power threshold to a default value when the PDU 100 is turned ON. In various implementations, the controller 200 stores one or more previous values for the user set current threshold or the user set power threshold and automatically sets the threshold to a stored value. The user may update the user set current threshold or the user set power threshold at any time (e.g., using user inputs 135).

In the example process 300, the controller 200 polls each of the outlets 115 to determine, for example, how much current and/or power each outlet 115 draws (at block 306). The current and/or power draw determined during the polling process may indicate how much power a device connected to the respective outlet 115 will draw during operation (e.g., during a charging cycle). The controller 200 may monitor a respective current sensor 230 associated with each outlet 115 to determine the current and/or power draw. In various implementations, the controller 200 determines the power draw by multiplying the current value sensed at the respective current sensor 230 with the voltage input via the power input cord 110 (e.g., via the power input module 205). In some examples, the controller 200 determines an average current draw over time and/or an average power draw over time. In various implementations, the controller 200 polls the outlets by turning on each outlet 115 individually, determining an average current draw and/or an average power draw, and then turning off the outlet 115. In some examples, the controller 200 polls the outlets 115 by turning on banks of two or more outlets 115, determining the average current draw and/or average power draw of each outlet 115, and turning off the bank of outlets 115. Additional processes for polling outlets 115 are described in greater detail below.

In the example process 300, the controller 200 determines which outlets 115 can be turned on without causing the total current draw to exceed the user set current threshold or the total power draw to exceed the user set power threshold and turns on each of the outlets 115 that have been determined can be turned on (at block 308). In various implementations, the controller 200 turns on as many outlets 115 as possible according to priority order. In some examples, the controller 200 maximizes the number of outlets 115 that are turned on. In various implementations, the controller 200 maximizes a total current draw or power draw of the outlets 115. Additional processes for turning on outlets 115 are described in greater detail below.

In the example process 300, once the outlets 115 are on, the controller 200 monitors the total current draw or total power draw of the PDU 100 (e.g., by monitoring the current sensor 225, by monitoring the current sensors 230 associated with each outlet that is turned on and summing the monitored current values, by monitoring all the current sensors 230 and summing the monitored current values, etc.) and compares the total current draw or total power draw of the PDU 100 with the user set current threshold or the user set power threshold (at decision block 310). In response to the total current draw or the total power draw of the PDU 100 exceeding the user set current threshold or the user set power threshold (“YES” at decision block 310), the controller 200 turns off one or more outlets 115 (at block 312). In various implementations, the controller 200 turns off the lowest priority outlet 115 that is powered on. In some examples, the controller 200 turns off banks of one or more outlets 115 grouped according to reverse-priority order.

In the example process 300, the controller 200 determines whether an outlet of interest has been turned off (at decision block 314). In various implementations, the outlet of interest may correspond to the outlet 115 that, after it is turned off, causes the total current draw or the total power draw of the PDU 100 to fall below the user set current threshold or the user set power threshold. In response to the controller 200 determining that the outlet of interest has not been turned off (“NO” at decision block 314), the controller 200 turns off one or more additional outlets 115 at block 312. In response to the controller 200 determining that the outlet of interest has been turned off (“YES” at decision block 314), the controller 200 again determines which outlets 115 can be turned on without causing the total current draw to exceed the user set current threshold or the total power draw to exceed the user set power threshold and turns on each of the outlets 115 that have been determined can be turned on at block 308.

In various implementations, the controller 200 is configured to turn off outlets 115 until it reaches (and turns off) the outlet of interest more quickly than a wall circuit breaker can trip (e.g., according to a dynamic trip time). Thus, the time required for the controller 200 to turn off outlets 115 until it reaches (and turns off) the outlet of interest may depend on the thermal trip curve of common circuit breakers found in commercial and residential settings.

In the example process 300, the controller 200 monitors the total current or power draw of the PDU 100, compares the total current or power draw of the PDU 100 with the user set current threshold or the user set power threshold, and, in response to the total current draw or the total power draw of the PDU 100 not exceeding the user set current threshold or the user set power threshold (“NO” at decision block 310), determines whether additional outlets 115 can be turned on and turned on each of the additional outlets that have been determined can be turned on (at decision block 316). In response to determining that additional outlets 115 can be turned on (“YES” at decision block 316), the controller 200 may turn on additional outlets 115 according to any of the previous described processes and/or the processes described in greater detail below (at block 318).

After the controller 200 turns on additional outlets 115 (if able) at block 318, the controller 200 again monitors the total current or power draw of the PDU 100 and compares the total current or power draw of the PDU 100 with the user set current threshold or the user set power threshold (at decision block 310). In response to determining that additional outlets 115 cannot be turned on (“NO” at decision block 316), the controller 200 again monitors the total current or power draw of the PDU 100 and compares the total current or power draw of the PDU 100 with the user set current threshold or the user set power threshold (at decision block 310).

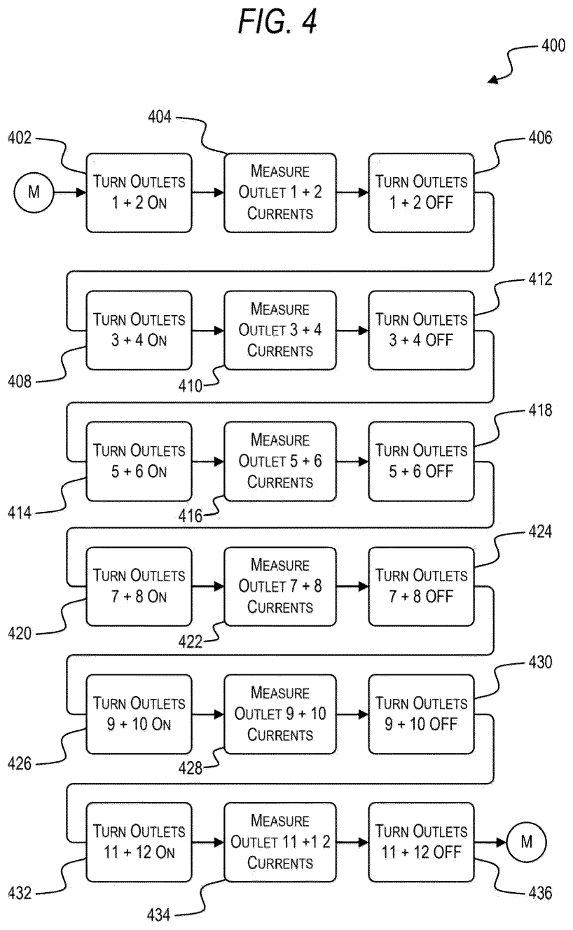

FIG. 4 illustrates an example process 400 for polling outlets 115 of the PDU 100. In the example process 400, the controller 200 turns on outlets 115 in groups of one or more starting from the highest priority outlets 115 to the lowest priority outlets 115, measures the current draw of each of the outlets 115, stores the current draw of each outlet 115 (e.g., in the memory 245), and turns off the group of outlets 115 before repeating the process with the next group of outlets (e.g., until all outlets have been polled). While the process 400 is described with reference to current measurements, the process 400 may be implemented using power measurements instead.

In various implementations, current or power thresholds are not enforced during the polling process 400. The stored current values may then be used by the controller 200 to determine which outlets 115 can be energized or turned on. In some examples, during the polling process 400, each outlet 115 is turned on for a time period (e.g., one second) before it is turned back off. If a current value for the outlet 115 cannot be determined within the time period, the outlet may be assumed to be low risk of causing the PDU 100 to trip the circuit breaker. A fast load for an outlet 115 may be a load that reaches a steady state within the time period (e.g., a light, a fan, etc.). A slow load for the outlet 115 may be an outlet that does not reach a steady state within the time period (e.g., a battery pack charger). A no load outlet 115 (e.g., an outlet at which a current value is not detected) may be treated like a slow load outlet 115.

In some examples, the polling process 400 is only performed once (e.g., upon startup of the PDU 100). The stored values from previous polling processes can be overwritten or not used in favor of more recent, current measurements. For example, when an outlet 115 is on, a value for the current draw can be monitored and stored in the memory 245. Thus, the stored current draw of the outlet 115 determined during the polling process 400 can be replaced with a more up-to-date value. The polling process 400 shown in FIG. 4 illustrates the example where the PDU 100 has 12 outlets 115-1-115-12. However, in other implementations, the PDU 100 may have any number of outlets 115, and the process 400 may be scaled accordingly.

In the example process 400, the controller 200 turns on outlets 115-1 and 115-2 (e.g., the two highest priority outlets) at block 402. In the example process 400, the controller 200 measures the currents drawn by the outlets 115-1 and 115-2 and stores the respective current draw values to the memory 245 (at block 404). In the example process 400, the controller 200 turns the outlets 115-1 and 115-2 off (at block 406). In the example process 400, the controller 200 turns on outlets 115-3 and 115-4 (e.g., the two next-highest priority outlets) at block 408. In the example process 400, the controller 200 measures the currents drawn by the outlets 115-3 and 115-4 and stores the respective current draw values to the memory 245 (at block 410). In the example process 400, the controller 200 turns the outlets 115-3 and 115-4 off (at block 412).

In the example process 400, the controller 200 turns on outlets 115-5 and 115-6 (e.g., the two next-highest priority outlets) at block 414. In the example process 400, the controller 200 measures the currents drawn by the outlets 115-5 and 115-6 and stores the respective current draw values to the memory 245 (at block 416). In the example process 400, the controller 200 turns the outlets 115-5 and 115-6 off (at block 418). In the example process 400, the controller 200 turns on outlets 115-7 and 115-8 (e.g., the two next-highest priority outlets) at block 420. In the example process 400, the controller 200 measures the currents drawn by the outlets 115-7 and 115-8 and stores the respective current draw values to the memory 245 (at block 422). In the example process 400, the controller 200 turns the outlets 115-7 and 115-8 off (at block 424).

In the example process 400, the controller 200 turns on outlets 115-9 and 115-10 (e.g., the two next-highest priority outlets) at block 426. In the example process 400, the controller 200 measures the currents drawn by the outlets 115-9 and 115-10 and stores the respective current draw values to the memory 245 (at block 428). In the example process 400, the controller 200 turns the outlets 115-9 and 115-10 off (at block 430). In the example process 400, the controller 200 turns on outlets 115-11 and 115-12 (e.g., the two next-highest priority outlets) at block 432. In the example process 400, the controller 200 measures the currents drawn by the outlets 115-11 and 115-12 and stores the respective current draw values to the memory 245 (at block 434). In the example process 400, the controller 200 turns the outlets 115-11 and 115-12 off (at block 436).

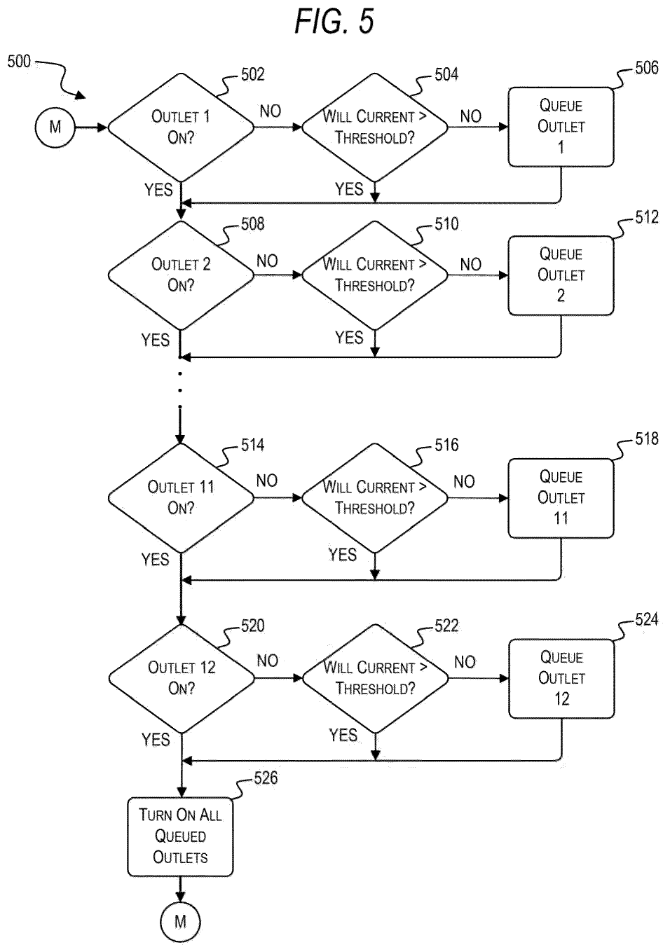

FIG. 5 illustrates an example process 500 for turning on outlets 115 of the PDU 100. In various implementations, the controller 200 adds the outlets 115 that can be turned on without causing the PDU 100 to exceed the user set current threshold to a virtual queue and turns on each queued outlet 115 at the same time. While the process 500 is described with reference to current measurements, the process 500 may be implemented using power measurements instead. For example, the controller 200 cycles through the outlets 115 in priority order (e.g., from the highest priority to the lowest priority). The controller 200 may select an outlet 115 and determine whether the selected outlet 115 is on. In response to determining that the selected outlet 115 is on, the controller 200 moves on and selects the next outlet.

In response to determining that the selected outlet 115 is not on, the controller 200 determines whether turning on the selected outlet 115 (and any queued higher-priority outlets 115) will cause the total current draw of the PDU 100 to exceed the user set current threshold. For example, the controller 200 may compute the total current draw of the PDU 100 using stored current draws (e.g., determined during the polling process) from the memory 245. In various implementations, the controller 200 maintains a running total of what the total current draw of the PDU 100 should be when all queued outlets 115 are turned on. In response to determining that turning on the selected outlet 115 (and any queued higher-priority outlets 115) will not cause the total current draw of the PDU 100 to exceed the user set current threshold, the controller 200 adds the selected outlet 115 to the queue (of outlets to be turned on) and selects the next outlet 115.

In response to the controller 200 determining that turning on the selected outlet 115 (and any queued higher-priority outlets 115) will cause the total current draw of the PDU 100 to exceed the user set current threshold, the controller 200 does not add the selected outlet to the queue and instead selects the next outlet 115. After cycling through each outlet 115, the controller 200 may simultaneously turn on all of the queued outlets 115. Thus, in various implementations, the controller 200 only turns on the outlets 115 that will keep the total current at or below the user set current threshold.

The process 500 shown in FIG. 5 illustrates the example where the PDU 100 has 12 outlets 115-1-115-12. However, in other implementations, the PDU 100 may have any number of outlets, and the process 500 may be scaled accordingly. In the example process 500, the controller 200 selects the highest priority outlet 115-1 and determines whether the selected outlet 115-1 is currently powered on (at decision block 502). In response to determining that the selected outlet 115-1 is powered on (“YES” at decision block 502), the controller 200 selects the next outlet 115-2 (e.g., the outlet 115 having the next highest priority). In response to determining that the selected outlet 115-1 is not powered on (“NO” at decision block 502), the controller 200 determines whether turning the selected outlet 115-1 on will cause the total current draw of the PDU 100 to exceed the user set current threshold (at decision block 504). In various implementations, the controller 200 compares the sum of the stored current value for the selected outlet 115-1 (e.g., from the memory 245) and the total current draw of the PDU 100 with the user set current threshold.

In response to the controller 200 determining that the sum of the stored current value for the selected outlet 115-1 and the total current draw PDU 100 will exceed the user set threshold (“YES” at decision block 504), the controller 200 selects the next outlet 115-2. In response to the controller 200 determining that the sum of the stored current value for the selected outlet 115-1 and the total current draw PDU 100 will not exceed the user set threshold (“NO” at decision block 504), the controller 200 adds the selected outlet 115-1 to the queue (at block 506) and selects the next outlet 115-2.

After the controller 200 selects the next outlet 115-2 (e.g., the outlet 115 having the next highest priority), the controller 200 determines whether the selected outlet 115-2 is currently powered on (at decision block 508). In response to determining that the selected outlet 115-2 is powered on (“YES” at decision block 508), the controller 200 selects the next outlet 115-3 (e.g., the outlet 115 having the next highest priority). In response to determining that the selected outlet 115-2 is not powered on (“NO” at decision block 508), the controller 200 determines whether turning the selected outlet 115-2 on will cause the total current draw of the PDU 100 to exceed the user set current threshold (at decision block 510). In various implementations, the controller 200 compares the sum of the stored current value for the selected outlet 115-2 (e.g., from the memory 245), any outlets 115 in the queue, and the total current draw of the PDU 100 with the user set current threshold.

In response to the controller 200 determining that the sum of the stored current value for the selected outlet 115-2 and the total current draw PDU 100 will exceed the user set threshold (“YES” at decision block 510), the controller 200 selects the next outlet 115-3. In response to the controller 200 determining that the sum of the stored current value for the selected outlet 115-2 and the total current draw PDU 100 will not exceed the user set threshold (“NO” at decision block 510), the controller 200 adds the selected outlet 115-2 to the queue (at block 512) and selects the next outlet 115-3. The controller 200 may proceed through the remaining outlets 115 of the PDU 100 (e.g., in priority order) as previously described. Accordingly, the description of the process 500 as applied to outlets 115-3-115-10 is omitted for the sake of conciseness.

After the controller 200 processes the outlet 115-10 and selects the next outlet 115-11 (e.g., the outlet 115 having the next highest priority), the controller 200 determines whether the selected outlet 115-11 is currently powered on (at decision block 514). In response to determining that the selected outlet 115-11 is powered on (“YES” at decision block 514), the controller 200 selects the next outlet 115-12 (e.g., the outlet 115 having the next highest priority). In response to determining that the selected outlet 115-11 is not powered on (“NO” at decision block 514), the controller 200 determines whether turning the selected outlet 115-11 on will cause the total current draw of the PDU 100 to exceed the user set current threshold (at decision block 516). In various implementations, the controller 200 compares the sum of the stored current value for the selected outlet 115-11 (e.g., from the memory 245), any outlets 115 in the queue, and the total current draw of the PDU 100 with the user set current threshold.

In response to the controller 200 determining that the sum of the stored current value for the selected outlet 115-11 and the total current draw PDU 100 will exceed the user set threshold (“YES” at decision block 516), the controller 200 selects the next outlet 115-12. In response to the controller 200 determining that the sum of the stored current value for the selected outlet 115-11 and the total current draw PDU 100 will not exceed the user set threshold (“NO” at decision block 516), the controller 200 adds the selected outlet 115-11 to the queue (at block 518) and selects the next outlet 115-12.

After the controller 200 selects the next outlet 115-12 (e.g., the outlet 115 having the next highest priority), the controller 200 determines whether the selected outlet 115-12 is currently powered on (at decision block 520). In response to determining that the selected outlet 115-12 is powered on (“YES” at decision block 520), the controller 200 turns on the queued outlets 115 (at block 526). In various implementations, the controller 200 turns on the queued outlets 115 simultaneously. In some examples, the controller 200 turns on the queued outlets in banks of one or more (for example, according to priority order or reverse priority order).

In response to determining that the selected outlet 115-12 is not powered on (“NO” at decision block 520), the controller 200 determines whether turning the selected outlet 115-12 on will cause the total current draw of the PDU 100 to exceed the user set current threshold (at decision block 522). In various implementations, the controller 200 compares the sum of the stored current value for the selected outlet 115-12 (e.g., from the memory 245), any outlets 115 in the queue, and the total current draw of the PDU 100 with the user set current threshold.

In response to the controller 200 determining that the sum of the stored current value for the selected outlet 115-12 and the total current draw PDU 100 will exceed the user set threshold (“YES” at decision block 522), the controller 200 turns on the queued outlets 115 (at block 526). In response to the controller 200 determining that the sum of the stored current value for the selected outlet 115-12 and the total current draw PDU 100 will not exceed the user set threshold (“NO” at decision block 522), the controller 200 adds the selected outlet 115-12 to the queue (at block 524) and turns on the queued outlets 115 (at block 526).

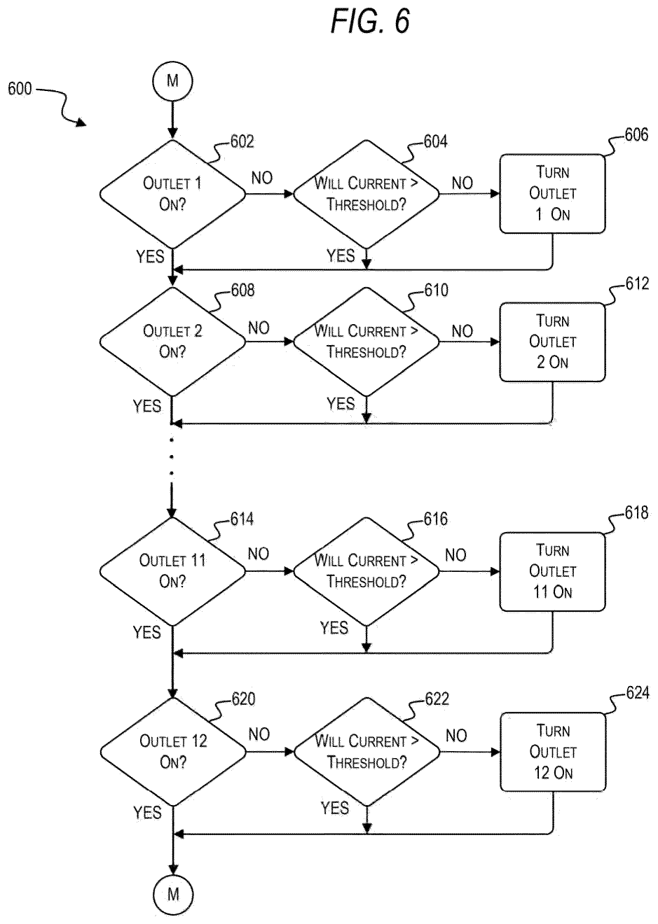

FIG. 6 illustrates an example process 600 for turning on outlets 115 of the PDU 100. The process 600 is similar to the process 500. However, instead of first queuing outlets 115 for simultaneous turn on (or turn on in banks), outlets 115 are sequentially turned on upon checking each outlet and determining that the outlet 115 can be turned on without exceeding the current threshold. While the process 600 is described with reference to current measurements, the process 600 may be implemented using power measurements instead. Thus, in the example process 600 of FIG. 6, blocks 602-606 are similar to blocks 502-506 of the example process 500 of FIG. 5 except that at block 606, the controller 200 turns the outlet 115-1 on instead of adding the outlet 115-1 to the queue.

In the example process 600 of FIG. 6, blocks 608-612 are similar to blocks 508-512 of the example process 500 of FIG. 5 except that at block 612, the controller 200 turns the outlet 115-2 on instead of adding the outlet 115-2 to the queue. In the example process 600 of FIG. 6, blocks 614-618 are similar to blocks 514-518 of the example process 500 of FIG. 5 except that at block 618, the controller 200 turns the outlet 115-11 on instead of adding the outlet 115-11 to the queue. In the example process 600 of FIG. 6, blocks 620-624 are similar to blocks 520-524 of the example process 500 of FIG. 5 except that at block 624, the controller 200 turns the outlet 115-12 on instead of adding the outlet 115-12 to the queue.

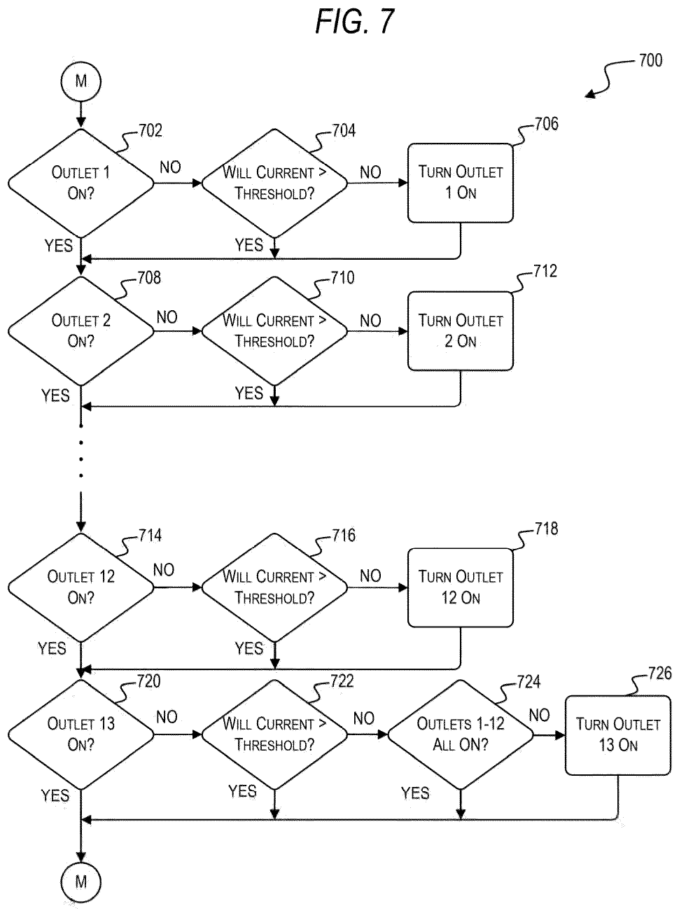

FIG. 7 illustrates an example process 700 for turning on outlets 115 of the PDU 100. The process 700 is similar to the process 600. However, in some implementations, the PDU 100 includes an additionally fully functional outlet, such as a thirteenth outlet 115-13. The additional fully functional outlet 115-13 may be similar to the other outlets 115 (e.g., includes an associated current sensor 230, switch 235, etc.) but be generally inaccessible to the user during normal operation. In various implementations, the additional fully functional outlet 115-13 may be positioned within the housing 105, covered by a covering, etc. In some examples, the additional fully functional outlet 115-13 may be used for future expansion of the internal components of the PDU 100, used during manufacturer testing, etc. In various implementations, the additional fully functional outlet 115-13 is the lowest priority outlet 115.

While the process 700 is described with reference to current measurements, the process 700 may be implemented using power measurements instead. In the example process 700 of FIG. 7, blocks 702-712 are similar to blocks 602-612 of the example process 600 of FIG. 6, and blocks 714-718 are similar to blocks 620-624. However, in the example process 700, the controller 200 selects the additional fully functional outlet 115-13 after the controller 200 processes the outlet 115-12. For example, the controller 200 selects the additional fully-functional outlet 115-13 in response to determining that the outlet 115-12 is on (“YES” at decision block 714), in response to determining that turning on the outlet 115-12 would cause the total current draw of the PDU 100 to exceed the user set current threshold (“YES” at decision block 716), or after turning on the outlet 115-12 at block 718.

After selecting the fully functional outlet 115-13, the controller 200 determines whether the selected additional fully functional outlet 115-13 is currently powered on (at decision block 720). In response to determining that the selected additional fully functional outlet 115-13 is powered on (“YES” at decision block 720), the process 700 returns to the main process 300. In response to determining that the selected additional fully functional outlet 115-13 is not powered on (“NO” at decision block 720), the controller 200 determines whether turning the additional fully functional outlet 115-13 on would cause the total current draw of the PDU 100 to exceed the user set current threshold (at decision block 722). In response to determining that turning the additional fully functional outlet 115-13 on would cause the total current draw of the PDU 100 to exceed the user set current threshold (“YES” at decision block 722), the process 700 returns to the main process 300.

In response to determining that turning the additional fully-functional outlet 115-13 on would not cause the total power draw of the PDU 100 to exceed the user set current threshold (“NO” at decision block 722), the controller 200 determines whether all of the higher priority outlets 115 of the PDU 100 are on (at decision block 724). In various implementations, the higher priority outlets 115 may include all of the outlets 115 of the PDU 100 aside from the additional fully-functional outlet 115-13, such as outlets 115-1-115-12. In response to determining that all of the higher priority outlets 115 are on (“YES” at decision block 724), the controller 200 does not turn the additional fully functional outlet 115-13 on and the process 700 returns to the main process 300. In response to determining that all of the higher priority outlets 115 are not on (“NO” at decision block 724), the controller 200 turns the additional fully functional outlet 115-13 on at block 726 and the process 700 returns to the main process 300.

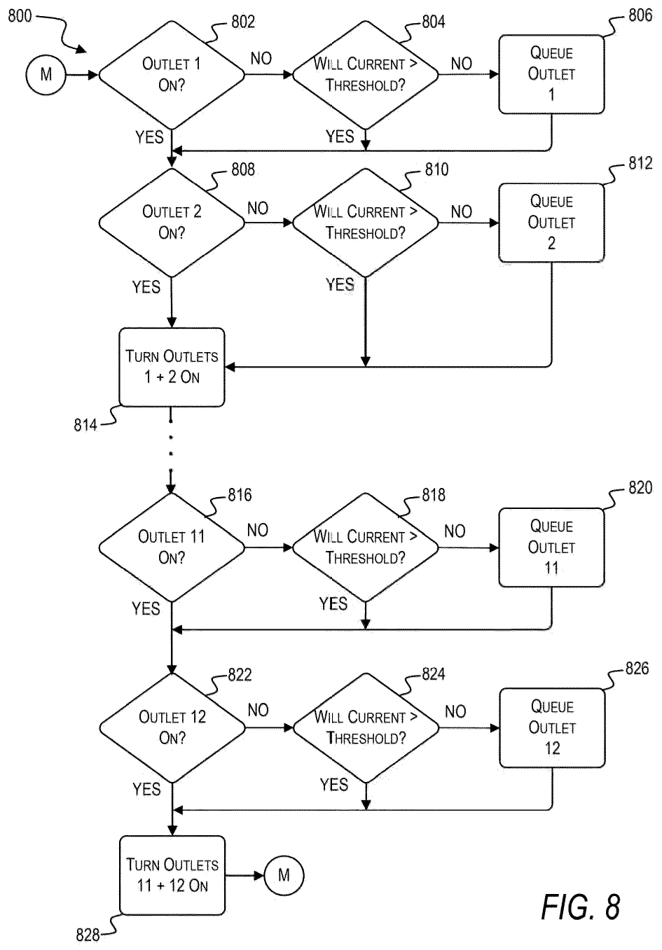

FIG. 8 illustrates an example process 800 for turning on outlets 115 of the PDU 100. The process 800 of FIG. 8 is similar to the process 500 of FIG. 5. However, in the process 800, after the controller 200 checks a pair of outlets 115 (e.g., outlets 115-1 and 115-2, outlets 115-3 and 115-4, etc.), the controller 200 will turn on both outlets 115 or none of the two outlets 115. For example, if either outlet 115 of a pair of outlets 115 is queued, then both outlets 115 of the pair will be turned on. If neither outlet 115 of the pair is queued, then neither outlet 115 of the pair will be turned on. This process 800 may be repeated for each of the outlet pairs in the PDU 100 (e.g., for each of the six outlet pairs in the twelve outlet PDU 100 illustrated in FIG. 1). While the process 800 is described with reference to current measurements, the process 800 may be implemented using power measurements instead.

Thus, in the example process 800, blocks 802-812 are similar to blocks 502-512 of the example process 500. However, in the example process 800, after the controller 200 processes the first pair of outlets 115-1 and 115-2 at blocks 802-812, the controller 200 turns both outlets 115-1 and 115-2 on at block 814 in response to either of the outlets 115-1 or 115-2 being added to the queue at block 806 or 812. In the example process 800, blocks 816-826 are similar to blocks 514-524 of the example process 500. However, in the example process 800, after the controller 200 processes the first pair of outlets 115-11 and 115-12 at blocks 802-812, the controller 200 turns both outlets 115-11 and 115-12 on at block 828 in response to either of the outlets 115-11 or 115-12 being added to the queue at block 820 or 826.

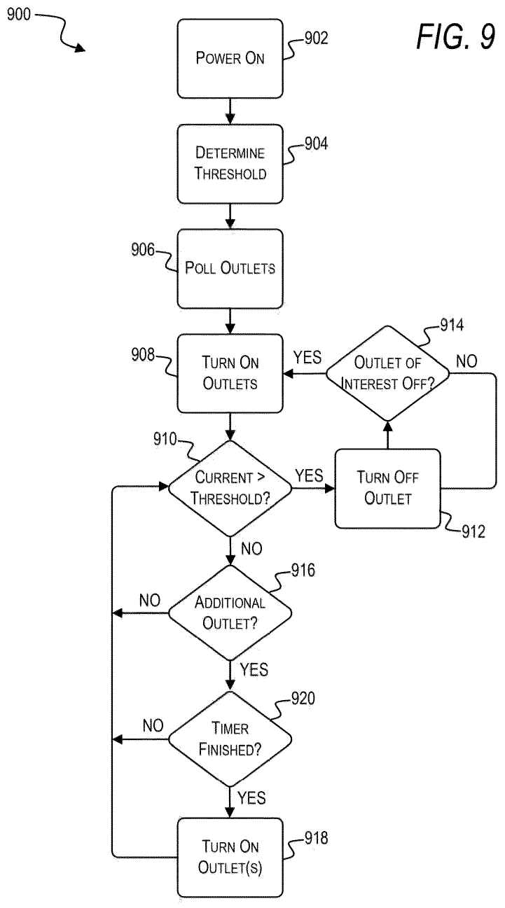

FIG. 9 illustrates a process 900 for controlling operation of the PDU 100. The process 900 of FIG. 9 is similar to the process 300 of FIG. 3. For example, blocks 902-918 of the process 900 may be similar to blocks 302-318 of the process 300. However, the process 900 further includes a timer. For example, the process 900 includes a decision block 920 (implementing a timer) between blocks 916 and 918. The timer may be set, for example, each time an outlet 115 is turned on or each time a pair of outlets 115 (e.g., outlets 115-1 and outlets 115-2) are queued for turn on. The timer functionality introduces a delay that prevents outlets 115 from being turned on too fast. For example, after the controller 200 determines that additional outlets can be turned on (“YES” at decision block 916), the controller 200 determines whether the timer has finished (at decision block 920). The controller 200 may turn on the additional outlets 115 at block 918 only in response to the timer being finished (“YES” at decision block 916).

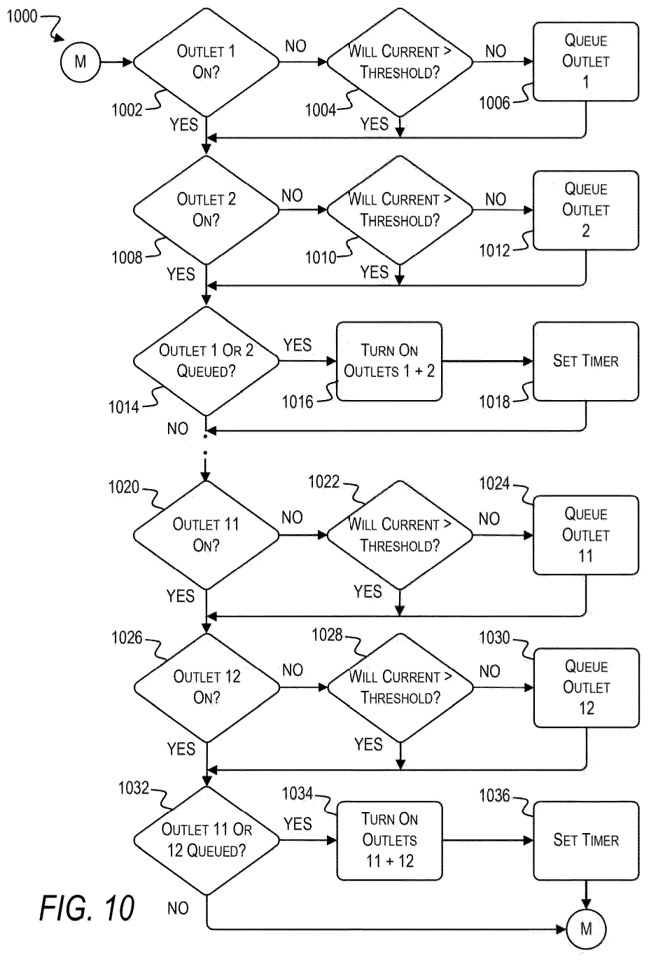

FIG. 10 illustrates a process 1000 for turning on outlets 115 of the PDU 100. The process 1000 may be a continuation of the process 900 (for example, describing blocks 908 and/or 918 in additional detail). The process 1000 of FIG. 10 may be similar to the process 800 of FIG. 8. However, in the process 1000, the timer is set in response to a pair of outlets 115 being turned on. For example, blocks 1002-1012 of the process 1000 may be similar to blocks 802-812 of the process 800. However, in the process 1000, after processing the first outlet pair (e.g., outlets 115-1 and 115-2) at blocks 1002-1012, the controller 200 determines whether either outlet 115-1 or 115-2 were added to the queue at decision block 1014. In response to determining that neither outlet 115-1 nor 115-2 were added to the queue (“NO” at decision block 1014), the controller 200 continues processing the next pair of outlets 115 (e.g., outlets 115-3 and 115-4). In response to determining that either outlet 115-1 or 115-2 were added to the queue (“YES” at decision block 1014), the controller 200 turns on the outlets 115-1 and 115-2 (at block 1016) and sets the timer (at block 1018) before proceeding to process the next pair of outlets 115.

Blocks 1020-1030 of the process 1000 may be similar to blocks 816-826 of the process 800. However, in the process 1000, after processing the final outlet pair (e.g., outlets 115-11 and 115-12) at blocks 1020-1030, the controller 200 determines whether either outlet 115-11 or 115-12 were added to the queue at decision block 1032. In response to determining that neither outlet 115-11 nor 115-12 was added to the queue (“NO” at decision block 1032), the process 1000 returns to the main process 900. In response to determining that either outlet 115-11 or 115-12 were added to the queue (“YES” at decision block 1032), the controller 200 turns on the outlets 115-11 and 115-12 (at block 1034) and sets the timer (or resets the timer if the timer is already running) at block 1036 before the process 1000 proceeds back to the main process 900.

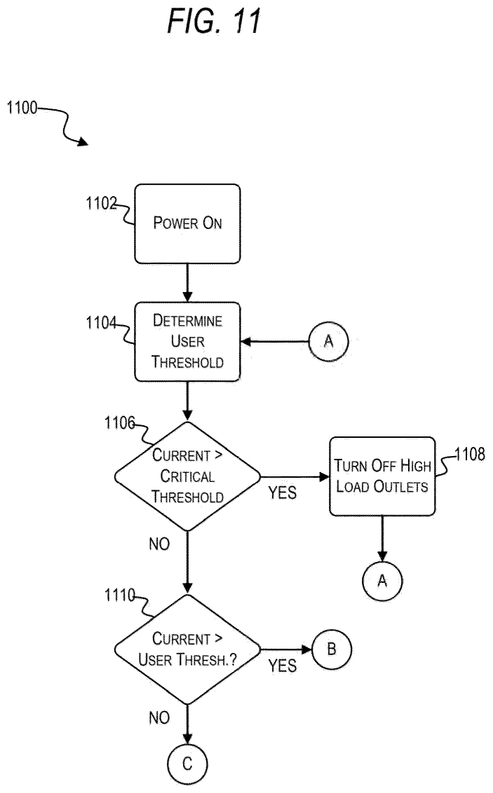

FIGS. 11-13 illustrate a process 1100 for controlling operation of the PDU 100. In the example process 1100, the PDU 100 may be powered on (at block 1102). In the example process 1100, the controller 200 determines the user set current threshold (at block 1104). While the process 1100 is described with reference to current measurements, the process 1100 may be implemented using power measurements instead. In the example process 1100, the controller 200 monitors the total current draw of the PDU 100 and determines whether the total current draw exceeds a critical threshold (at decision block 1106). In various implementations, the critical threshold is a pre-programmed threshold and may be set to a value greater than or equal to the maximum programmable user set current threshold. In some examples, the critical threshold may be set to a value above the rated current limit of the circuit that the PDU 100 is plugged in to (e.g., 16A for a 15A circuit).

In response to determining that the total current draw of the PDU 100 exceeds the critical threshold (“YES” at decision block 1106), the controller 200 turns off high load outlets 115 (at block 118). High load outlets 115 may be outlets drawing current exceeding a threshold value. In various implementations, the threshold value is about 4 A. In some examples, the controller 200 turns off all outlets 115 drawing more current than the threshold value simultaneously. In various implementations, the controller 200 turns off outlets 115 drawing more current than the threshold in blocks of one or more outlets (e.g., in reverse priority order). After the controller 200 turns off high load outlets at block 1108, the process 1100 returns to block 1104.

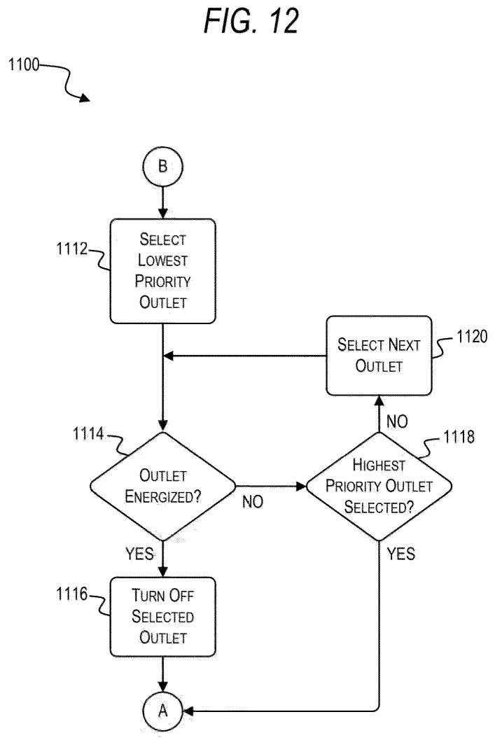

In response to determining that the total current draw of the PDU 100 does not exceed the critical threshold (“NO” at decision block 1106), the controller 200 determines whether the total current draw of the PDU 100 exceeds the user set current threshold (at decision block 1110). In response to the total current draw of the PDU 100 exceeding the user set current threshold (“YES” at decision block 1110), the controller 200 selects the lowest priority outlet 115 at block 1112 (see FIG. 12) and determines whether the selected outlet 115 is energized (at decision block 1114). In response to determining that the selected outlet 115 is energized (“YES” at decision block 1114), the controller 200 turns off the selected outlet 115 at block 1116 and the process 1100 returns to block 1104.

In response to determining that the selected outlet 115 is not energized (“NO” at decision block 1114), the controller 200 determines whether the highest priority outlet 115 is selected (at decision block 1118). In response to determining that the highest priority outlet 115 is selected (“YES” at decision block 1118), the process 1100 returns to block 1104. In response to determining that the highest priority outlet 115 is not selected (“NO” at decision block 1118), the controller 200 selects the outlet 115 having the next highest priority at block 1120 and the process 1100 returns to decision block 1114.

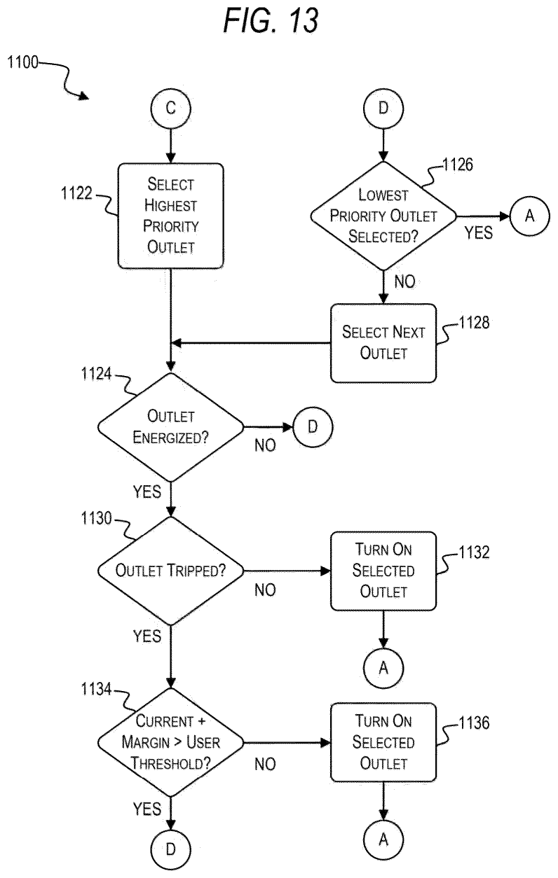

In response to the total current draw of the PDU 100 not exceeding the user set current threshold (“NO” at decision block 1110), the controller 200 selects the highest priority outlet 115 (at block 1122) (see FIG. 13). In the example process 1100, the controller 200 determines whether the selected outlet 115 is energized (at decision block 1124). In response to determining that the selected outlet is not energized (“NO” at decision block 1124), the controller 200 determines whether the lowest priority outlet 115 is selected (at decision block 1126). In response to determining that the lowest priority outlet 115 is selected (“YES” at decision block 1126), the process 1100 returns to block 1104. In response to determining that the lowest priority outlet 115 is not selected (“NO” at decision block 1126), the controller 200 selects the next outlet 115 at block 1128 and the process returns to decision block 1124.

In response to determining that the selected outlet 115 is energized (“YES” at decision block 1124), the controller 200 determines whether the selected outlet 115 was previously tripped (e.g., previously turned off in response to the overall current draw of the PDU 100 exceeding the user set current threshold) at decision block 1130. In response to determining that the that the selected outlet was not previously tripped (“NO” at decision block 1130), the controller 200 turns on the selected outlet 115 at block 1132 and the process returns to block 1104. In response to determining that the selected outlet was previously tripped (“YES” at decision block 1130), the controller 200 determines whether the total current draw of the PDU 100 plus an additional safety margin exceeds the user set threshold current (at decision block 1134). In various implementations, the addition safety margin may be a sum of the current draw of the selected outlet 115 when it was previously tripped plus an additional value. In some examples, the additional value may be about 1.5 A.

In response to determining that the total current draw of the PDU 100 plus the additional safety margin exceeds the user set threshold current (“YES” at decision block 1134), the process 1100 returns to decision block 1126. In response to determining that the total current draw of the PDU 100 plus the additional safety margin does not exceeds the user set threshold current (“NO” at decision block 1134), the controller 200 turns on the selected outlet 115 at block 1136 and the process 1100 returns to block 1104.

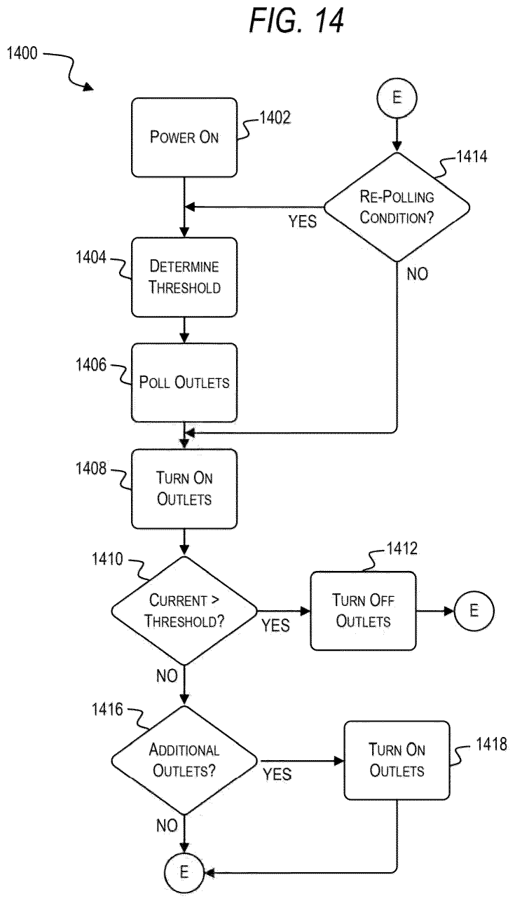

FIG. 14 illustrates a process 1400 for controlling operation of the PDU 100. In the example process 1100, the PDU 100 may be powered on (at block 1402). In the example process 1400, the controller 200 determines the user set current threshold (at block 1404). While the process 1400 is described with reference to current measurements, the process 1400 may be implemented using power measurements instead. In the example process 1400, the controller 200 polls the outlets 115 (at block 1406). For example, the controller 200 polls the outlets according to any of the previously described techniques. In various implementations, the controller 200 turns on each outlet 115 for a period of time (e.g., about 1 second), measures the current value of the outlet (e.g., an average value over the period of time), turns off the outlet 115, and selects the next outlet 115 for polling. In some examples, the controller 200 polls the outlets 115 according to priority order. In various implementations, the controller 200 polls the outlets 115 according to reverse priority order.

In the example process 1400, the controller 200 turns on selected outlets 115 (at block 1408). In various implementations, the controller 200 first selects a combination of outlets 115 that can be turned on without causing the overall current draw of the PDU 100 to exceed the user set current threshold, then turns on the selected outlets 115 simultaneously. In some examples, the controller 200 selects a combination of outlets 115 according to priority (e.g., higher priority outlets 115 are selected before lower priority outlets 115). In various implementations, the controller 200 selects a combination of outlets 115 to maximize a number of outlets 115 selected. In some examples, the controller 200 selects a combination of outlets 115 to maximize the total current draw of the PDU 100. In various implementations, the controller 200 selects a combination of outlets based on a combination of the previously described factors.

In the example process 1400, the controller 200 determines whether the total current draw of the PDU 100 exceeds the user set current threshold (at decision block 1410). In response to the total current draw of the PDU 100 exceeding the user set current threshold (“YES” at decision block 1410), the controller 200 turns off all outlets 115 of the PDU 100 at block 1412, and the controller 200 determines whether a re-polling condition is met (at decision block 1414). In various implementations, the re-polling condition is met after a pre-determined time duration has elapsed since the outlets 115 were last polled. In some examples, the re-polling condition is met after the outlets 115 are turned off in response to the total current draw of the PDU 100 exceeding the user set current threshold (e.g., a trip condition). In various implementations, the re-polling condition is met in response to the controller 200 determining that one or more outlets 115 have erratic current readings.

In response to the re-polling condition being met (“YES” at decision block 1414), the process 1400 returns to block 1404. In response to the re-polling condition not being met (“NO” at decision block 1414), the process 1400 returns to block 1408. In response to the total current draw of the PDU 100 not exceeding the user set current threshold (“NO” at decision block 1410), the controller 200 determines whether any additional outlets 115 can be turned on (at decision block 1416). In various implementations, the controller 200 determines whether any additional outlets 115 can be turned on based on any of the previously described techniques (e.g., with reference to block 1408). In response to the controller 200 determining that one or more additional outlets 115 can be turned on (“YES” at decision block 1416), the controller 200 turns on the additional outlets at block 1418 and the process 1400 returns to decision block 1414. In response to the controller 200 determining that no additional outlets 115 can be turned on (“NO” at decision block 1416), the process 1400 returns to decision block 1414.

Thus, embodiments described herein provide, among other things, a power distribution unit including a plurality of intelligently controlled outlets. Various features and advantages are set forth in the following claims.

What is claimed is:

1. A power distribution unit comprising:
a plurality of outlets; and
a controller configured to:
poll the plurality of outlets to determine a polled electrical load of each outlet,
add one or more outlets of the plurality of outlets to a queue based on a comparison of the polled electrical loads and a user set threshold,
connect the queued outlets to a power input,
monitor a total electrical load of the power distribution unit, and
disconnect, in response to determining that the total electrical load exceeds the user set threshold, one or more outlets of the plurality of outlets from the power input.

2. The power distribution unit of claim 1, wherein, to poll the plurality of outlets, the controller is configured to:
connect a first pair of outlets of the plurality of outlets to the power input;
measure an electrical load of each outlet of the first pair of outlets; and
disconnect the first pair of outlets of the plurality of outlets from the power input.

3. The power distribution unit of claim 2, wherein:
each outlet of the plurality of outlets is assigned a priority; and
to poll the plurality of outlets, the controller is configured to:
connect a second pair of outlets of the plurality of outlets to the power input, the second pair of outlets having a lower priority than the first pair of outlets,
measure an electrical load of each outlet of the second pair of outlets, and
disconnect the second pair of outlets of the plurality of outlets from the power input.

4. The power distribution unit of claim 1, wherein, to add one or more outlets of the plurality of outlets to the queue, the controller is configured to:
select a first outlet of the plurality of outlets;
determine whether connecting the first outlet to the power input will cause the total electrical load of the power distribution unit to exceed the user set threshold; and
add, in response to determining that connecting the first outlet to the power input will not cause the total electrical load of the power distribution unit to exceed the user set threshold, the first outlet to the queue.

5. The power distribution unit of claim 4, wherein:
each outlet of the plurality of outlets is assigned a priority; and
to add one or more outlets of the plurality of outlets to the queue, the controller is configured to:
select a second outlet of the plurality of outlets, the second outlet having a lower priority than the first outlet,
determine whether connecting the second outlet and any queued outlets to the power input will cause the total electrical load of the power distribution unit to exceed the user set threshold; and
add, in response to determining that connecting the second outlet and any queued outlets to the power input will not cause the total electrical load of the power distribution unit to exceed the user set threshold, the second outlet to the queue.

6. The power distribution unit of claim 1, wherein the controller is configured to disconnect outlets from the power input in reverse priority order in response to determining that the total electrical load exceeds the user set threshold.

7. The power distribution unit of claim 1, wherein the controller is further configured to:
determine, in response to determining that the total electrical load does not exceed the user set threshold, whether any additional outlets of the plurality of outlets can be connected to the power input without causing the total electrical load to exceed the user set threshold;
initiate, in response to determining that additional outlets of the plurality of outlets can be connected to the power input without causing the total electrical load to exceed the user set threshold, a timer; and
connect, in response to the timer elapsing, the additional outlets to the power input.

8. The power distribution unit of claim 1, further comprising:
a plurality of switches, each switch of the plurality of switches being associated with a respective outlet of the plurality of outlets;
a plurality of outlet sensors, each outlet sensor of the plurality of sensors being associated with a respective outlet of the plurality of outlets and configured to sense an electrical load of the respective outlet; and
a main sensor configured to sense the total electrical load of the power distribution unit at the power input;
wherein the controller is configured to:
actuate each switch of the plurality of switches to connect or disconnect the respective outlet,
determine an electrical load of each outlet by monitoring a respective outlet sensor, and
determine the total electrical load of the power distribution unit by monitoring the main sensor.

9. The power distribution unit of claim 1, wherein the polled electrical loads and the total electrical load are current values.

10. The power distribution unit of claim 1, wherein the polled electrical loads and the total electrical load are power values.

11. A method for controlling a power distribution unit, the method comprising:
polling a plurality of outlets of the power distribution unit to determine a polled electrical load of each outlet;
adding one or more outlets of the plurality of outlets to a queue based on a comparison of the polled electrical loads and a user set threshold;
connecting the queued outlets to a power input;
monitoring a total electrical load of the power distribution unit; and
disconnecting, in response to determining that the total electrical load exceeds the user set threshold, one or more outlets of the plurality of outlets from the power input.

12. The method of claim 11, wherein polling the plurality of outlets includes:
connecting a first pair of outlets of the plurality of outlets to the power input;
measuring an electrical load of each outlet of the first pair of outlets; and
disconnecting the first pair of outlets of the plurality of outlets from the power input.

13. The method of claim 12, wherein:
each outlet of the plurality of outlets is assigned a priority; and
polling the plurality of outlets includes:
connecting a second pair of outlets of the plurality of outlets to the power input, the second pair of outlets having a lower priority than the first pair of outlets,
measuring an electrical load of each outlet of the second pair of outlets, and
disconnecting the second pair of outlets of the plurality of outlets from the power input.

14. The method of claim 11, wherein adding one or more outlets of the plurality of outlets to the queue includes:
selecting a first outlet of the plurality of outlets;
determining whether connecting the first outlet to the power input will cause the total electrical load of the power distribution unit to exceed the user set threshold; and
adding, in response to determining that connecting the first outlet to the power input will not cause the total electrical load of the power distribution unit to exceed the user set threshold, the first outlet to the queue.

15. The method of claim 14, wherein:
each outlet of the plurality of outlets is assigned a priority; and
adding one or more outlets of the plurality of outlets to the queue includes:
selecting a second outlet of the plurality of outlets, the second outlet having a lower priority than the first outlet,
determining whether connecting the second outlet and any queued outlets to the power input will cause the total electrical load of the power distribution unit to exceed the user set threshold; and
adding, in response to determining that connecting the second outlet and any queued outlets to the power input will not cause the total electrical load of the power distribution unit to exceed the user set threshold, the second outlet to the queue.

16. The method of claim 11, further comprising:
disconnecting outlets from the power input in reverse priority order in response to determining that the total electrical load exceeds the user set threshold.

17. The method of claim 11, further comprising:
determining, in response to determining that the total electrical load does not exceed the user set threshold, whether any additional outlets of the plurality of outlets can be connected to the power input without causing the total electrical load to exceed the user set threshold;
initiating, in response to determining that additional outlets of the plurality of outlets can be connected to the power input without causing the total electrical load to exceed the user set threshold, a timer; and
connecting, in response to the timer elapsing, the additional outlets to the power input.

18. The method of claim 11, wherein the power distribution unit includes:
a plurality of switches, each switch of the plurality of switches being associated with a respective outlet of the plurality of outlets;
a plurality of outlet sensors, each outlet sensor of the plurality of sensors being associated with a respective outlet of the plurality of outlets and configured to sense an electrical load of the respective outlet;
a main sensor configured to sense the total electrical load of the power distribution unit at the power input; and
the method further comprising:
actuating each switch of the plurality of switches to connect or disconnect the respective outlet,
determining an electrical load of each outlet by monitoring a respective outlet sensor, and
determining the total electrical load of the power distribution unit by monitoring the main sensor.

19. The method of claim 11, wherein the polled electrical loads and the total electrical load are current values.

20. The method of claim 11, wherein the polled electrical loads and the total electrical load are power values.
